(19) United States
(12) Patent Application Publication
(10) Pub. No.: US 2009/0076882 A1
(43) Pub. Date: Mar. 19, 2009

(54) MULTI-MODAL RELEVANCY MATCHING

(75) Inventors: Tao Mei, Beijing (CN); Xian-Sheng Hua, Beijing (CN); Shipeng Li, Beijing (CN)

Correspondence Address: LEE & HAYES, PLLC, 601 W. RIVERSIDE AVENUE, SUITE 1400, SPOKANE, WA, 99201, US

(73) Assignee: Microsoft Corporation, Redmond, WA (US)

(21) Appl. No.: 11/855,872

(22) Filed: Sep. 14, 2007

(51) Int. Cl. G06Q 30/00; G06F 17/10; G06F 17/30; G06F 17/40

(52) U.S. Cl. 705/10

(57) ABSTRACT

This document describes techniques capable of associating relevant entities, such as advertisements, with insertion points within a media file. These techniques calculate a global relevancy between entities and the media file. These techniques may also calculate a local relevancy between the entities and one or more insertion points within the media file. Both global and local relevancies may employ textual and non-textual information. With use of the calculated global and local relevancies, the techniques associate one or more entities with each of the one or more insertion points in the media file. These techniques thus enable, for each insertion point, associating a most relevant entity for a particular insertion point with the insertion point. Therefore, when a user consumes the media file the user may also consume a most relevant entity at and for each insertion point in the media file.

### BACKGROUND

Online video services enable users to search for, view, author, and share user-created or user-uploaded videos. These services continue to increase in popularity. Multitudes of users are not only viewing videos on a daily basis, but are also sharing these videos with friends, family members, coworkers, and the like. This large and ever-increasing audience makes videos provided by these online video services prime advertising targets.

As advertising experts know, targeting an advertisement to a corresponding demographic maximizes the effectiveness of the advertisement. As such, advertising experts strive to place certain advertisements in front of certain types of individuals. For instance, these experts may desire to show an advertisement for pet supplies to pet owners. Within the online video services industry, however, current techniques to target advertisements to particular demographics may be greatly enhanced.

### SUMMARY

This document describes techniques capable of associating relevant entities, such as advertisements, with insertion points within a media file. In some embodiments, these techniques calculate a global relevancy between entities and the media file. These techniques may also calculate a local relevancy between the entities and one or more insertion points within the media file. Both global and local relevancies may employ textual and non-textual information. With use of the calculated global and local relevancies, the techniques may associate one or more entities with each of the one or more insertion points in the media file. In some embodiments, these techniques thus enable, for each insertion point, associating a most relevant entity for a particular insertion point with the insertion point.

This Summary is provided to introduce a selection of concepts in a simplified form that are further described below in the Detailed Description. This Summary is not intended to identify key or essential features of the claimed subject matter, nor is it intended to be used as an aid in determining the scope of the claimed subject matter. The term “techniques,” for instance, may refer to system(s), method(s), and/or computer-readable instructions as permitted by the context above and throughout the document.

### BRIEF DESCRIPTION OF THE CONTENTS

The detailed description is described with reference to accompanying figures. In the figures, the left-most digit(s) of a reference number identifies the figure in which the reference number first appears. The use of the same reference numbers in different figures indicates similar or identical items where feasible.

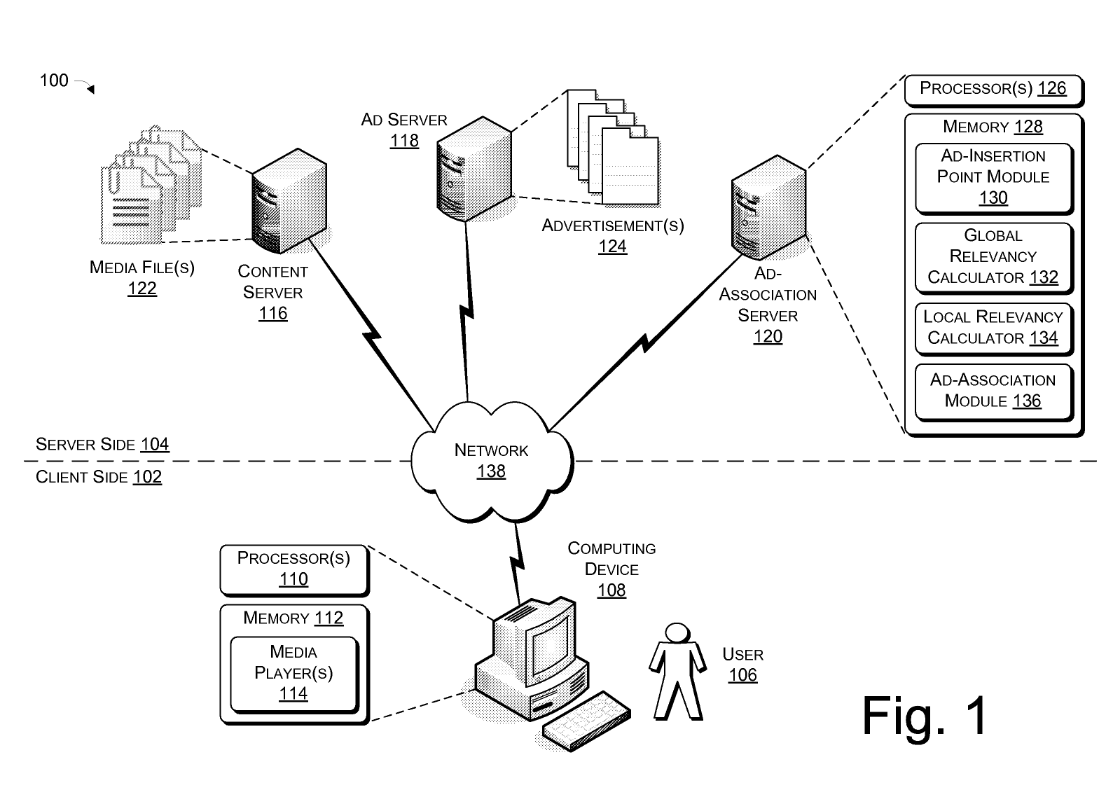

FIG. 1 illustrates an architecture for associating advertisements with insertion points in a media file and for enabling a user to consume the media file and the associated advertisements.

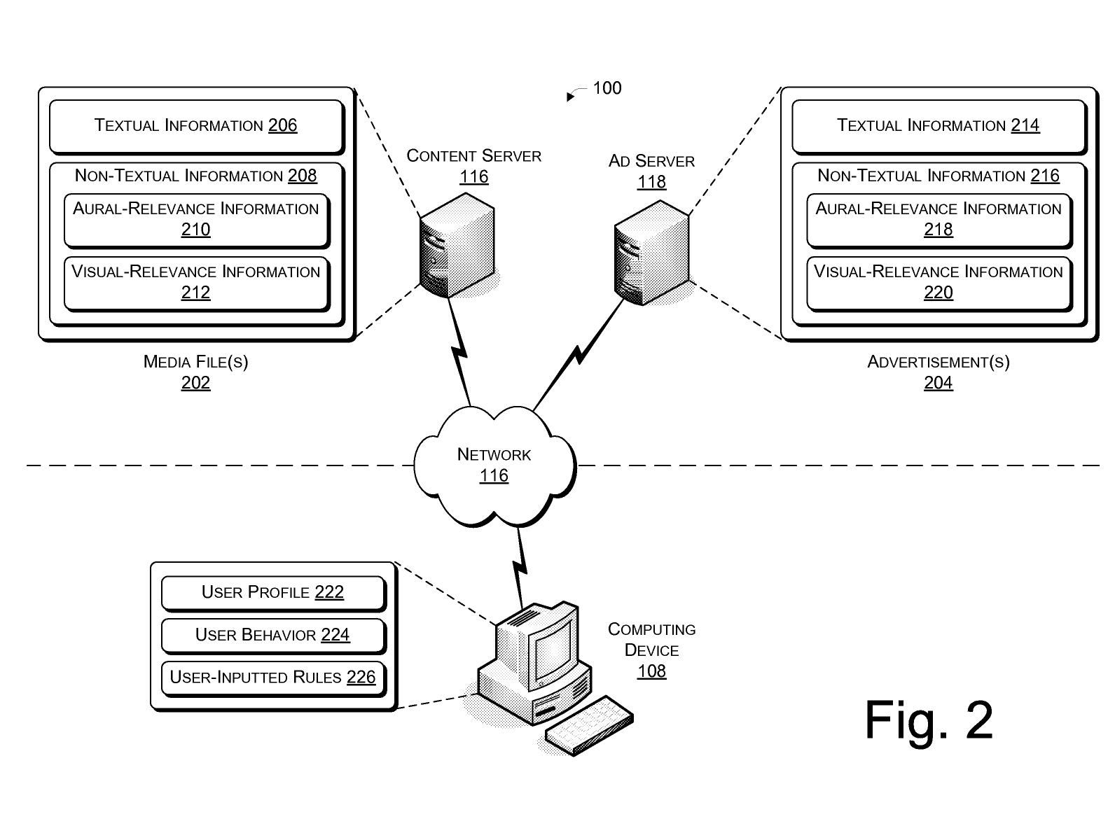

FIG. 2 depicts illustrative elements of a media file, an advertisement, and illustrative elements stored on the computing device of FIG. 1.

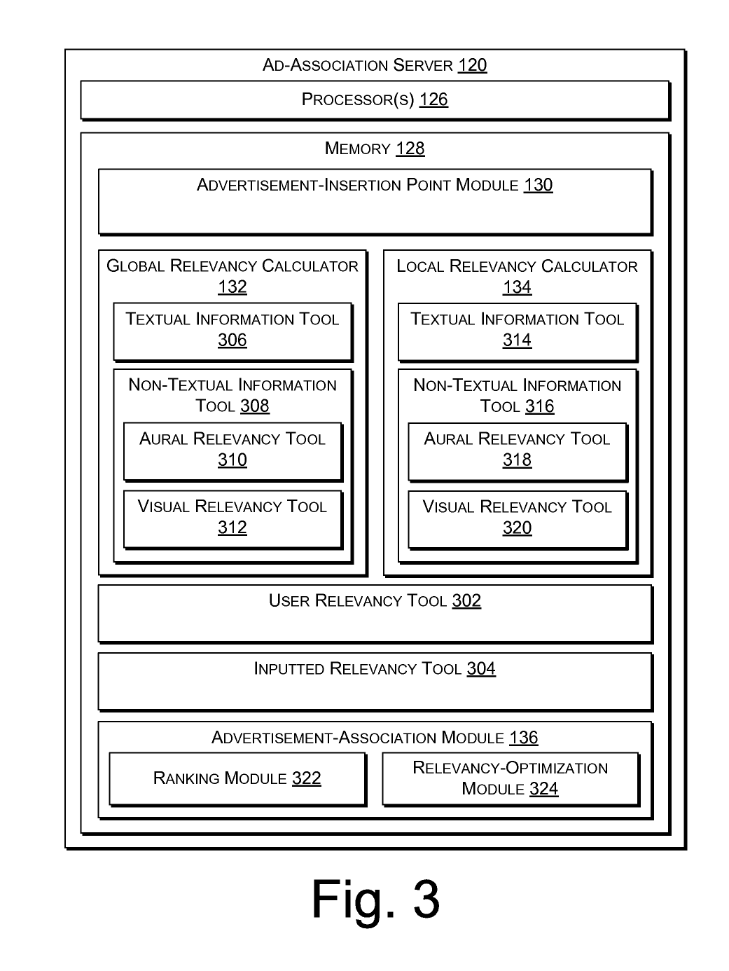

FIG. 3 depicts illustrative components of the advertisement-association server of FIG. 1.

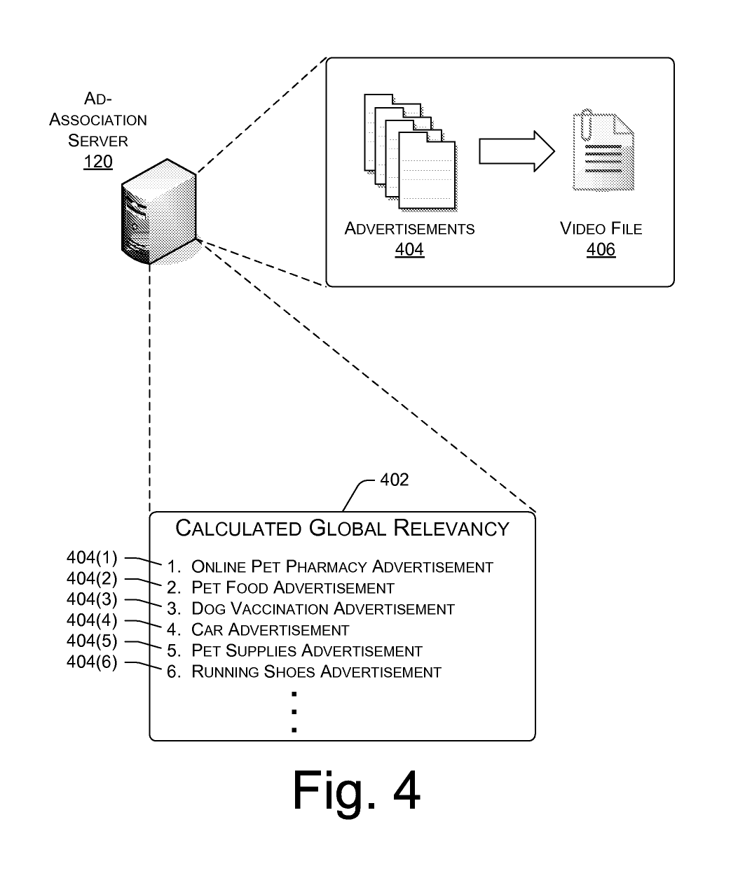

FIG. 4 depicts an illustrative example of calculated global relevancies for each advertisement of a group of advertisements and a particular media file.

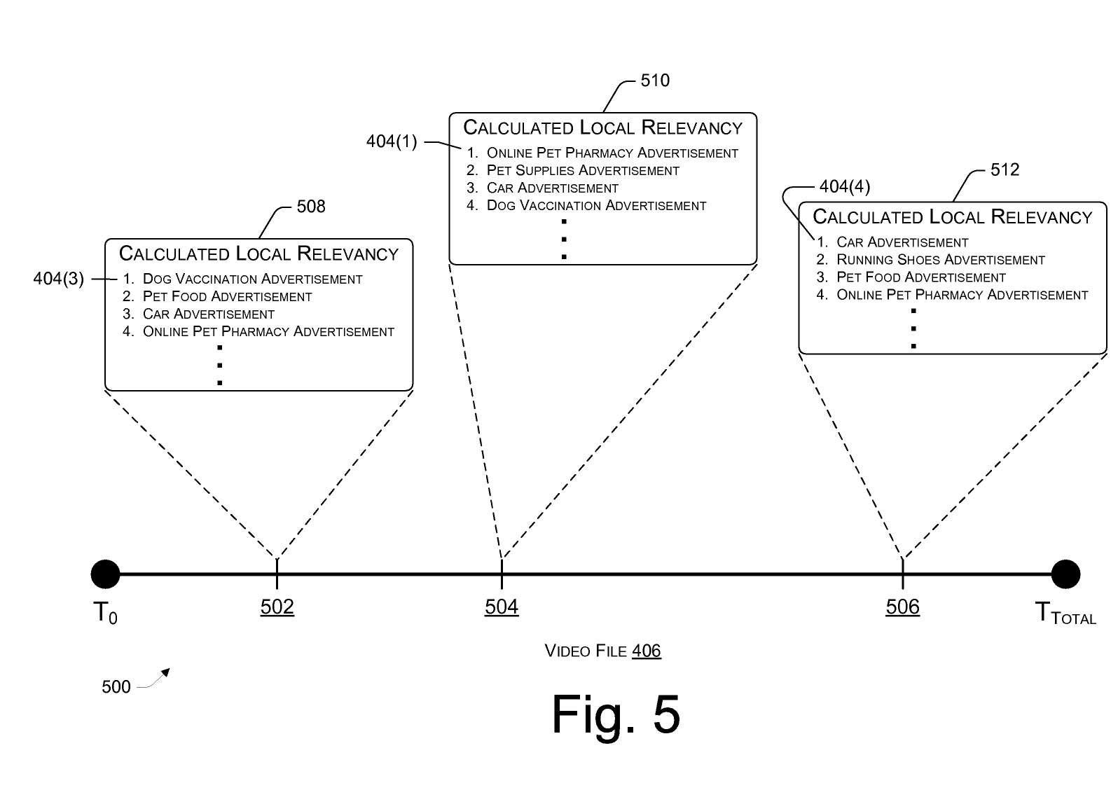

FIG. 5 depicts an illustrative example of calculated local relevancies for each advertisement of the group of advertisements of FIG. 4 and each of three ad-insertion points of the media file.

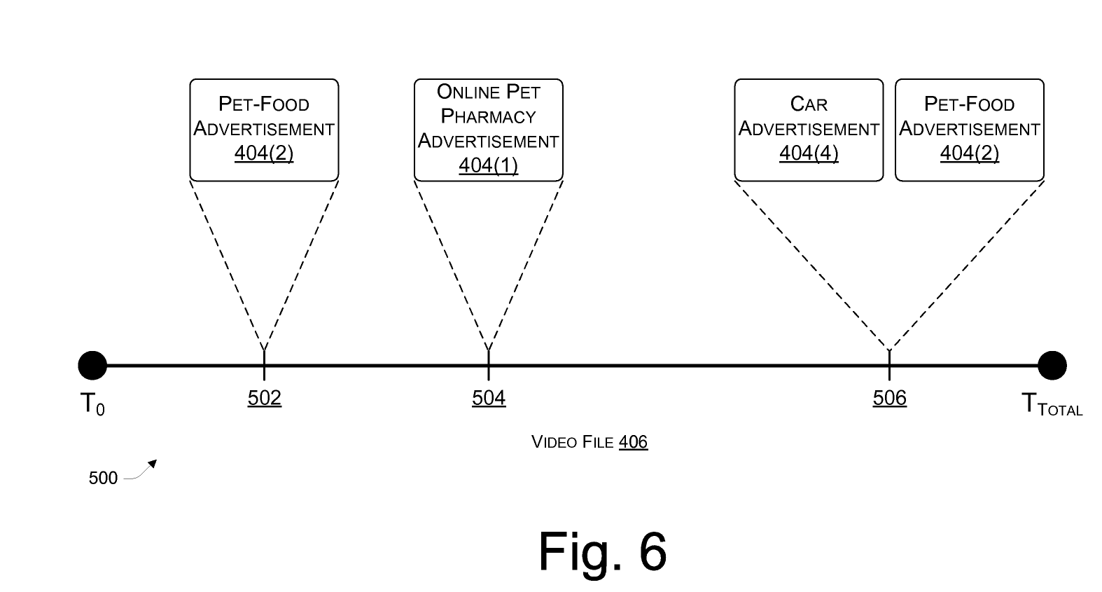

FIG. 6 depicts an illustrative example of associating one or more advertisements of the group of advertisements with each of the three ad-insertion points. The advertisements are associated based, at least in part, on the calculated global and local relevancies of FIGS. 3 and 4.

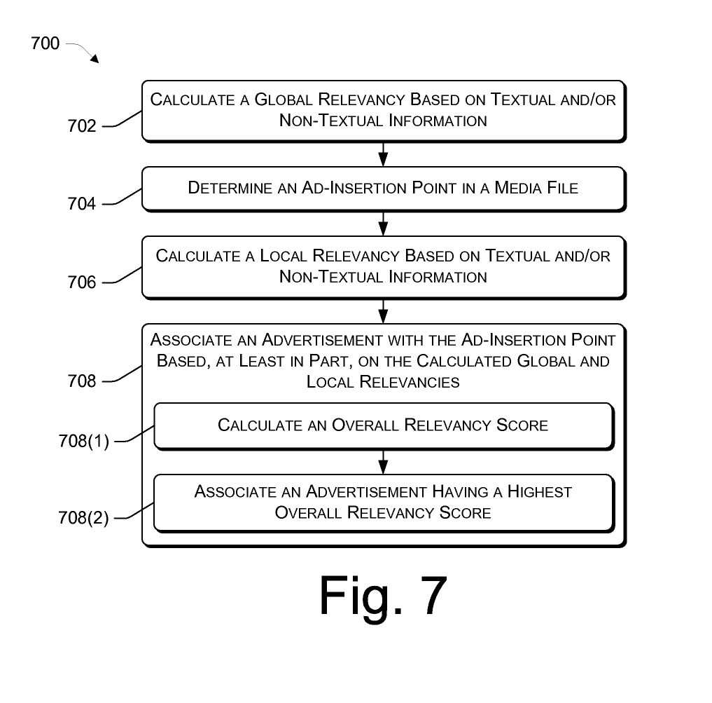

FIGS. 7-9 are flow diagrams of illustrative processes of implementing relevancy matching between entities, such as advertisements, and insertion points in a media file.

### DETAILED DESCRIPTION

The following discussion describes techniques capable of associating one or more entities with an insertion point of a media file, such as a video file or the like. An insertion point represents a position (e.g., measured in time, byte offset, etc.) of the media file with which an entity should be associated. The entities, meanwhile, may comprise advertisements, commercials, announcements, warnings, or any other type of message. In determining which of multiple entities to associate with the insertion point, these techniques may employ global and/or local relevancies to determine an entity that is most relevant. To determine a global relevancy, these techniques compare entity information with media file information, while the techniques determine a local relevancy by comparing entity information with insertion point information. Additionally, these techniques may employ local and/or global relevancies to associate one or more entities with multiple insertion points in the media file.

When an entity becomes associated with an insertion point, the entity may appear at the insertion point when a user consumes the media file. For instance, imagine that an associated entity comprises a video advertisement and the media file comprises a video file. Imagine further that a user begins playing the video file on a personal computer or the like. At a time of the video file corresponding to the insertion point, the personal computer will display to the user the associated video advertisement. This advertisement may appear between segments or portions of the video file, may overlay the video file, may appear adjacent the video file, or may otherwise appear at the time corresponding to the insertion point.

In the instant example, the associated video advertisement was chosen based, at least in part, on a local relevancy between the advertisement and the insertion point. As such, the transition from the video file to the advertisement is likely smoother than if a random advertisement were placed at the insertion point. This transition is also likely smoother than if the chosen advertisement were merely deemed relevant to the video file as a whole, rather than to the portion of the file corresponding to the insertion point. In addition, the associated video advertisement is likely much more relevant to the actual insertion point than if an advertisement were chosen at random. Finally, because user profiles and similar information may also be leveraged in choosing the advertisement, the advertisement will likely better target consuming users than would an advertisement chosen at random.

For purposes of discussion, multi-modal relevancy matching is described in the context of associating advertisements with media files to be consumed by a user in a networked environment. One illustrative implementation of this environment is provided below. However, it should be appreciated that the described relevancy techniques may be implemented in other environments and for other types of entities.

Illustrative System Architecture

FIG. 1 illustrates an illustrative architecture 100 that may employ the described multi-modal relevancy matching techniques. In illustrated architecture 100, some components reside on a client side 102 and other components reside on a server side 104. However, note that these components may reside in multiple other locations. For instance, all of the components of FIG. 1 may exist on client side 102 or on server side 104. Furthermore, two or more of the illustrated components may combine to form a single component at a single location.

As illustrated, however, client side 102 depicts a user 106 operating a computing device 108. Computing device 108 includes one or more processors 110, as well as memory 112 that includes a media player 114. User 106 may operate computing device 108 to download, stream, or otherwise consume a media file with use of media player 114. While FIG. 1 illustrates computing device 108 as a personal computer (PC), other implementations may employ, without limitation, a laptop computer, a mobile phone, a personal digital assistants (PDA), a portable media player (PMP) (e.g., a portable video player (PVP) and a digital audio player (DAP)), and/or the like.

Computing device 108 may connect, via a network 138, to server side 104 of architecture 100. Illustrated network 138 represents any one or combination of multiple different types of networks, such as cable networks, the Internet, and wireless networks. Server side 104, meanwhile, includes a content server 116, an advertisement server 118, and an advertisement-association server (ad-association server) 120. Content server 116 includes one or more media files 122, which may be delivered to one or more computing devices such as computing device 108 on client side 102.

Media files 122 generally comprise digital or analog content, such as videos, songs, movies, multimedia presentations, slide presentations, documents images, games, and/or any other type of content. In some cases, some or all of media files 122 comprise user-created and/or user-uploaded video files. Here, content server 116 may comprise a server of a video sharing website. Whatever the form of media files 122, however, content server 116 may provide these media files to devices such as computing device 108 by downloading, progressive downloading, streaming, emailing, or the like.

Advertisement server 118, meanwhile, includes one or more advertisements 124. Advertisements 124 may include video advertisements, audio advertisements, textual advertisements, animated advertisements, and/or any type of advertisement capable of conveying a message to a consuming user such as user 106. In instances where some or all of media files 122 comprise video files, some or all of advertisements 124 may similarly comprise video advertisements.

Multiple different entities may provide some or all of advertisements 124 to advertisement server 118. For instance, advertising agents, product makers, service providers, companies, individuals, grass-roots users, or any other entity who wishes to spread or convey a message may so provide some or all of advertisements 124. In addition, while a single advertisement server is shown, other environments may employ multiple servers and/or may employ advertisements without servers.

Next, ad-association server 120 functions to determine an advertisement, such as one of advertisements 124, to associate with a media file, such as one of media files 122. Additionally, ad-association server 120 may associate an advertisement with a particular ad-insertion point of the media file.

An ad-insertion point represents a position (e.g., measured in time, byte offset, etc.) of the media file with which an advertisement should be associated. An ad-insertion point may comprise a single instant in time (e.g., an ad is inserted in a file at a time of 0:15:00). In the example of a video media file and a video advertisement, for instance, the associated video advertisement may be played at the determined ad-insertion point when a user, such as user 106, plays the video. Conversely, an ad-insertion point may comprise a portion of the media file (e.g., an ad is played concurrently with a media file from 0:15:00 to 0:15:30). In the latter instances, the portion of the media file may comprise some or the entire file.

As illustrated, ad-association server 120 includes one or more processors 126, as well as memory 128. Memory 128 here includes an ad-insertion point module 130, a global relevancy calculator 132, a local relevancy calculator 134, and an ad-association module 136.

Ad-insertion point module 130 functions to determine one or more ad-insertion points within a media file. Module 130 may determine these points by actively establishing the points or by receiving an indication of the points by another entity. Given these one or more ad-insertion points, ad-association server 120 determines one or more advertisements to associate with each of the points based, at least in part, on relevancies of the advertisements.

Global relevancy calculator 132, for instance, calculates a relevancy between a particular advertisement and most or all of the media file itself (i.e., a global relevancy). That is, calculator 132 determines how relevant the particular advertisement is to the media file generally. As discussed below, calculator 132 may determine such relevancies with reference to multiple pieces of information about the particular advertisement and the media file.

Local relevancy calculator 134, meanwhile, calculates a relevancy between the particular advertisement and one or more of the determined ad-insertion points in the media file (i.e., a local relevancy). That is, calculator 134 determines how relevant the particular advertisement is to a particular ad-insertion point. Again, calculator 134 may base this relevancy on multiple pieces of information discussed in detail below.

Finally, ad-association module 136 associates one or more advertisements with one or more ad-insertion points based on the calculated global and/or local relevancies. Note that multiple (e.g., two or more) advertisements may be analyzed for each of multiple ad-insertion points that exist within a single media file, as illustrated and described with reference to FIGS. 4-6. Conversely, a single advertisement and/or a single ad-insertion point may exist for other media files. In any event, when an advertisement is associated, the advertisement may be shown, played, inserted, consumed, or otherwise employed at or near the corresponding ad-insertion point.

For instance, the advertisement may be embedded in the media file. Again employing the example of the video file and video advertisements, an embedded advertisement may be played at the ad-insertion point. When the advertisement finishes playing, then the media file may resume playing at the ad-insertion point. As such, an embedded advertisement may function similarly to a television commercial. Conversely, an embedded advertisement may be overlaid on the media file. For instance, a video advertisement could be shown overlaying some or a user's entire screen as the user views the video file.

In other instances, an associated advertisement may be shown adjacent or near the media file at a time corresponding to the insertion point. For instance, a separate stream may render the particular video and/or audio advertisement next to a streaming media file. In the case of a textual advertisement or the like, a user's screen may render the advertisement adjacent or near the video advertisement at a time corresponding to the ad-insertion point.

To highlight functions of ad-association server 120, consider the following illustrative but non-limiting example. Here, imagine that the media file is a short video about a dog and the dog's owner. Imagine also that one of advertisements 124 is a video advertisement for pet medications, while another comprises a video advertisement for a particular brand and type of car. Finally, imagine that ad-insertion point module 130 has determined two ad-insertion points in the video. The first of these points takes place when the video shows and discusses the dog, while the second occurs at a time when the video shows the dog and the owner driving down the highway, surrounded by cars.

First, global relevancy calculator 132 may calculate a global relevancy for each of the two advertisements. That is, calculator 132 may determine a relevancy between each of the advertisements and the video generally. Here, the global relevancy calculator may determine that the advertisement about the dog is more relevant to the video as a whole than is the car advertisement. This may be, for example, because the video relates more to dogs than cars, for reasons discussed in detail below.

Next, local relevancy calculator 134 may then calculate relevancies between each of the two advertisements and the first ad-insertion point, which again occurs at a time in the video that shows and discusses the dog. Here, imagine that calculator 134 calculates a local relevancy for the dog advertisement that is higher than the calculated local relevancy for the car advertisement. Ad-association module 136, meanwhile, may rely on one or both of the calculated relevancies to associate one of the advertisements with the first ad-insertion point. Here, imagine that module 136 associates the dog advertisement with the first ad-insertion point, due to this advertisement having a higher global relevancy and a higher local relevancy (for the first ad-insertion point) than the car advertisement.

Next, local relevancy calculator 134 may calculate relevancies between each of the two advertisements and the second ad-insertion point, which again shows the dog and owner driving on a highway filled with cars. Here, calculator 134 may calculate a higher local relevancy for the car advertisement than for the dog advertisement, again for reasons discussed in detail below. Ad-association module 136 may then associate one of the advertisements with the second-insertion point. Here, imagine that module 136 associates the car advertisement with the second ad-insertion point, due to the car advertisement's relatively high local relevancy for the second ad-insertion point.

Content server 116 may then stream the video to computing device 108, such that computing device 108 may consume the video with use of media player 114. When user 106 views the video, the video will play the dog advertisement at the first ad-insertion point and the car advertisement at the second ad-insertion point. User 106, who is a potential customer of the products that the advertisements depict, is thus exposed to advertisements that are not only relevant to the video generally but also to the particular insertion point of the video at which the advertisements appear. As discussed below, these advertisements may be further tailored by, for example, accounting for a profile or behavior or user 106.

Illustrative System Elements and Components

FIG. 2 depicts illustrative elements of a media file 202, an advertisement 204, and illustrative user-related elements stored on computing device 108 or some other entity. Each of these elements may be useful in calculating local and global relevancies for a given media file, advertisement, and ad-insertion point.

As illustrated, media file 202 includes textual information 206 as well as non-textual information 208. Both textual information 206 and non-textual information 208 may be leveraged in multiple ways to help compute advertisement relevancies and, hence, help associate contextually-relevant advertisements at ad-insertion points. Additionally, note that both textual information 206 and non-textual information 208 may contain information that relates to media file 202 generally, as well as information that relates to specific ad-insertion points of the media file.

Textual information 206 includes any text associated with media file 202, including titles, tags, keywords, markup, file metadata, users' comments, speech, closed captioning text, and/or the like. This information may be extracted from media file 202 in a variety of ways. For instance, speech recognition may be used to extract textual representations from the audio track (ASR). Text information embedded in video frames may also be extracted by videotext detection and optical character recognition (OCR). Of course, this textual information may vary with differing media file types. For instance, if media file 202 comprises a video file, then this file may include a corresponding textual description and/or a transcription of the audio played in the video.

Non-textual information 208, meanwhile, includes any information contained in or associated with the media file that is not reflected in associated text (e.g., contextual data). While this information is wide-ranging, the illustrated implementation shows that non-textual information 208 includes aural-relevance information 210 as well as visual-relevance information 212. Aural-relevance information 210 comprises contextual information about any audio that is associated with media file 202. For example, aural-relevance information 210 comprises a measure of the file's frequency of beats, both generally and at or near specific ad-insertion portions of media file 202.

Visual-relevance information 212, meanwhile, includes any contextual information about visual effects or content of media file 202. Visual-relevance information 212 may include the file's dominant colors, camera motions, object motions, texture, semantic classification, concepts, and/or the like. Again, visual-relevance information 212 may vary according to media file types.

In some instances, dominant colors may be detected by creating and analyzing a color histogram. For video files, a histogram may be created on a frame-by-frame basis. One or a number of frames on either side of an ad-insertion point may then be analyzed to determine an ad-insertion point's dominant color(s).

Camera motions, meanwhile, may be calculated for video files and refer to a speed, direction, and/or other information about the filming camera's motion. Object motions may also be calculated for video files and again relate to object speeds, directions, and/or the like. Again, known techniques may calculate both of these types of visual relevancy information.

Visual-relevance information 212 may also include the media file's texture and concept(s). Texture relates to a surface consistency or the like of a video frame and may be calculated using known methods, such as with reference to wavelets or autocorrelograms. Concept detection methods, meanwhile, may be employed to determine the media file's “concepts” or themes. These methods compare, for instance, video files against trained concept models. For instance, a concept model for “cars” or “dogs” may be trained by collecting a series of video clips relating to these themes. Once the model is trained, other video files may then be compared against the models to determine if the video files encompass the same concept.

For instance, return to the example of the dog/owner advertisement from above. Here, it is very likely that a large percentage of the video frames of the file illustrate the dog. When this video is compared against a trained model for “dogs” and/or “pets”, concept detection methods will likely determine that video generally matches one or both of these concepts.

In addition to storing a file's general concepts, visual-relevance information 212 may also include concepts for ad-insertion points of media file 202. For instance, remember that in the example above, the video file included an ad-insertion point occurring at a time in the video showing the dog and his owner driving down the highway, surrounded by cars. Here, a portion just before the ad-insertion point and a portion just after may be analyzed to determine any concepts of that particular ad-insertion point. Because both of these portions likely contain a number of cars, it is very likely that concept detection methods will determine that the ad-insertion point has a concept of “cars”, “vehicles”, and/or the like.

Advertisement 204, meanwhile, may contain some or all of the same types of information included within media file 202. For instance, advertisement 204 is shown to include textual information 214 and non-textual information 216. Non-textual information is shown to include aural-relevance information 218 and visual-relevance information 220 of advertisement 204. Some or all of the information within advertisement 204 may be the same or similar to the information as discussed above, although here this information relates to an advertisement rather than a media file.

Finally, FIG. 2 illustrates that computing device 108 may store a user profile 222, user behavior 224, and user-inputted rules 226. User profile 222 may relate to personal information about user 106. For instance, this information may note that user 106 is a male user from England that owns two dogs. This information may include the user's income, which may help determine what type of products or services to advertise to the user. As discussed in detail below, ad-association server 120 may employ this information when determining relevant advertisements for the user.

User-behavior 224, meanwhile, may relate to information such as websites the user has visited, media files the user has consumed, links the user has clicked on, media-file searches the user has conducted, and/or any other information that relates to the user's behavior. Again, ad-association server 120 may employ this information when determining relevant advertisements for the user.

Finally, user 106 may himself create user-inputted rules 226 that specify a type of advertisement that the user wishes or prefers to view. For instance, user 106 may specify that he would like to view advertisements about pet supplies, soccer, and travel. It is noted that while FIG. 2 illustrates user profile 222, user behavior 224, and user-inputted rules 226 as being stored on computing device 108, this information may additionally or alternatively be stored in other places. For instance, content server 116, advertisement server 118, and/or ad-association server 120 may store or otherwise have access to this information.

FIG. 3, meanwhile, depicts illustrative components of advertisement-association server 120 of FIG. 1. With use of these components, ad-association server 120 may compare textual and non-textual information of media files with corresponding textual and non-textual information of one or more advertisements to determine the advertisements' global and local relevancies. In general, the more that the information of an advertisement matches the corresponding information of the media file and/or the insertion point(s), the greater the relevancy. Once ad-association server 120 determines the global and local relevancies, the server may associate certain advertisements with certain ad-insertion points of a media file. For instance, server 120 may choose to maximize the relevancy between each pair of advertisement(s) and ad-insertion point.

As illustrated initially in FIG. 1, memory 128 of ad-association server 120 includes ad-insertion point module 130, global relevancy calculator 132, local relevancy calculator 134, and ad-association module 136. FIG. 3, meanwhile, also illustrates that server 120 may include a user relevancy tool 302 and an inputted relevancy tool 304.

As illustrated, global relevancy calculator 132 includes a textual information tool 306 and a non-textual information tool 308. Generally, textual information tool 306 functions to determine: (1) textual information of a media file generally, and (2) textual information of one or more advertisements. Tool 306 also compares the textual information of the media file generally with the textual information of the one or more advertisements, with the comparison being used in calculating global relevancies. Non-Textual information tool 308, meanwhile, generally functions to determine: (1) non-textual information of the media file generally, and (2) non-textual information of the one or more advertisements. Tool 308 also compares this information, with this comparison also being used in calculating global relevancies.

As illustrated, non-textual information tool 308 includes an aural relevancy tool 310 and a visual relevancy tool 312. Aural relevancy tool 310 compares aural-relevance information of the media file (e.g., the file's frequency of beats) with aural-relevance information of the advertisements. Similarly, visual relevancy tool 312 compares the file's visual-relevance information with the advertisements' visual-relevance information. These comparisons are again used in calculating a global relevancy for each of the one or more advertisements.

Local relevancy calculator 134 similarly contains a textual information tool 314 and a non-textual information tool 316. Here, textual information tool 314 determines: (1) textual information of one or more ad-insertion points of the media file, and (2) textual information of one or more advertisements. Tool 314 then compares this information to help determine a local relevancy for each of the advertisements. To determine an ad-insertion point's textual information, tool 314 may in some instances examine a portion of the media file that stretches from just before the ad-insertion point (e.g., 1 second before, 10 seconds before, 10 minutes before, etc.) to the ad-insertion point. Similarly, tool 314 may in some instances examine a portion of the media file that stretches from the ad-insertion point to just after the ad-insertion point (e.g., 1 second before, 10 seconds before, 10 minutes before, etc.). Additionally or alternatively, tool 310 may analyze both of these portions or some other portion of the media file.

In instances where tool 310 analyzes both portions that border the ad-insertion point, a weight may be assigned to each portion for the purpose of calculating a local relevancy. In some instances for video media files, the former portion (from just before the ad-insertion point to the ad-insertion point) may be weighted more heavily, as a smooth flow into the advertisement may be more important to the viewing user than a smooth flow from the advertisement back to the video.

Non-textual information tool 316, meanwhile, determines and compares: (1) non-textual information of the ad-insertion point(s), and (2) non-textual information of the one or more advertisements. Tool 316 then compares this information for use in calculating local relevancies. Non-textual information tool 316 includes an aural relevancy tool 318 and a visual relevancy tool 320. Again, tool 318 determines and compares aural-relevancy information for the ad-insertion points with aural-relevancy information for the advertisements. Tool 320 performs a similar function for visual-relevancy information. Again, tools 316, 318, and 320 may analyze this information just before and/or just after the ad-insertion point. In instances where both portions bordering the ad-insertion point are analyzed, weights may be assigned to each portion.

In addition to utilizing global and local relevancies to determine advertisements to associate with ad-insertion points, ad-association server 120 may also utilize other information provided by or related to user 106. Ad-association server 120 may also utilize other information provided by or related to the advertiser or the content provider. For instance, user relevancy tool 302 employs user-relevancy information, such as user profile 222, user behavior 224, and user-inputted rules 226, to help choose an advertisement to associate with an ad-insertion point of a media file. For instance, tool 302 may determine that user profile 222 indicates user 106's interests as “dogs” and “travel”. With this information, tool 302 may analyze textual and non-textual information from one or more advertisements to determine a relevancy between the advertisements and the user's interests.

Tool 302 may similarly compute these relevancies between the user's behavior and the advertisements. If, for instance, tool 302 determines that user 106 often views video files about European travel, then tool 302 may analyze the advertisements to find those having textual or non-textual information relating to “European travel”, “Europe”, “travel”, or the like.

Finally, tool 302 may reference user-inputted rules or preferences. For instance, if user 106 has explicitly specified particular advertisements interests, such as a desire to view advertisements related to pet supplies or travel, then tool 302 may again analyze advertisements with these user-inputted preferences in mind.

Inputted relevancy tool 304, meanwhile, employs inputted rules or preferences to help chose an advertisement to associate with an ad-insertion point. For instance, users, content providers, advertisers, or other entities may specify rules or preferences that ad-association server 120 should follow or weight when choosing an advertisement. For instance, a user may explicitly state that any associated advertisement should relate to pet supplies or travel. Additionally, a content provider may create a rule stating that at least one associated advertisement should be an advertisement for the content provider itself. Finally, an advertiser may create a rule specifying that a particular advertisement should be associated at least once in a certain percentage of media files. While a few exemplary rules have been illustrated, inputted relevancy tool 304 may leverage multiple other rules and/or preferences provided by the same or other entities.

Once ad-insertion points have been determined, global and local relevancies have been calculated, and user-information and inputted rules have been taken into account, ad-association module 136 may actually associate one or more advertisements with one or more insertion points. To do so, module 136 may include a ranking module 322 and a relevancy-optimization module 324.

Ranking module 322 functions to rank advertisements according to global and/or local relevancy. In one implementation, ranking module 322 first ranks a group of advertisements according to the advertisements' calculated global relevancies. Here, an advertisement with a highest relevancy to a given media file is ranked the highest. Next, ranking module 322 computes a ranking for each of the advertisements for each of the media file's respective ad-insertion points. For instance, if a media file has three ad-insertion points, then ranking module 322 may compute three local-relevancy rankings.

Relevancy-optimization module 324, meanwhile, receives the global and/or local relevancy rankings to determine one or more advertisements to associate with each ad-insertion point. In some instances, module 324 bases this determination on both the global and local relevancies. For instance, module 324 may assign a weight to the global relevancy ranking and another weight to the local relevancy ranking. Module 324 may then calculate an overall relevancy score for each ad-insertion point. In these instances, module 324 may associate, with a particular ad-insertion point, an advertisement (or multiple advertisements) having a highest overall relevancy score for the particular ad-insertion point. In other instances, however, module 324 may base its determination on global relevancy rankings or local relevancy rankings alone.

Different techniques may be employed by module 324 to maximize relevancy between advertisement(s) and a media file's ad-insertion point. For instance, module 324 may employ a heuristic searching algorithm (e.g., a genetic algorithm) to maximize the global and/or local relevancies. Conversely, module 324 may employ a rule-based approach. For instance, module 324 could first choose the best advertisement/ad-insertion point match, remove this advertisement and ad-insertion point from the analysis, and then move to the next best advertisement/ad-insertion point match. Module 324 could choose advertisements in this fashion until each ad-insertion point is associated with a particular advertisement.

Of course, while a few specific examples have been given, relevancy-optimization module 324 could choose advertisements for association based on relevancies in multiple other ways.

Illustrative Relevancy Matching Example

FIGS. 4-6 illustrate an illustrative but non-limiting example that employs the techniques described above. In this example, imagine that a single advertisement is to be associated with each of three ad-insertion points within a media file. Imagine also that the media file again comprises the video of the dog and the dog's owner.

FIG. 4 first illustrates an ordered list 402 of global relevancies that ad-association server 120 (and, more specifically, global relevancy calculator 132 and ranking module 322) has calculated and ranked. Each of these global relevancies is based on the similarity between each of a group of advertisements 404 and a particular video file 406, which again represents the short dog/owner video. Server 120 may have calculated these relevancies based on both textual and non-textual information of each of advertisements 404 and video file 406, as discussed above.

As illustrated a first advertisement 404(1), entitled “Online Pet Pharmacy Advertisement” has been deemed the most globally relevant advertisement to video file 406. In decreasing order thereafter, list 402 lists advertisements 404(2), (3), . . . , (6). As such, advertisement 404(2) (entitled “Pet Food Advertisement”) has been deemed the second-most globally relevant advertisement, and so on.

Next, FIG. 5 illustrates a timeline 500 corresponding to video file 406. As illustrated, the video begins at time T₀ and ends at time Tₜₒₜₐₗ. In the current example, three ad-insertion points 502, 504, and 506 exist within video file 406. For each ad-insertion point, ad-association server 120 (and, more specifically, local relevancy calculator 134 and ranking module 322) has calculated and ordered a list of local relevancies for each of advertisements 404. As such, a list 508 corresponds to ad-insertion point 502, while a list 510 corresponds to ad-insertion point 504 and a list 512 corresponds to ad-insertion point 506.

As illustrated by list 508, local relevancy calculator 134 calculated a highest local relevancy for advertisement 404(3) (entitled “Dog Vaccination Advertisement”) for ad-insertion point 502. Additionally, list 510 illustrates that advertisement 404(1) has a highest local relevancy for ad-insertion point 504. Finally, advertisement 404(4) (entitled “Car Advertisement”) has a highest local relevancy for ad-insertion point 506.

With use of the calculated global and local relevancies illustrated in FIGS. 4 and 5, respectively, ad-association module 136 then determines which one or more advertisements to associate with each ad-insertion point. In instances where ad-association module wishes to match the most relevant advertisements for each ad-insertion point with the respective ad-insertion point, module 136 may employ relevancy-optimization module 324, as discussed above.

For example, FIG. 6 represents that ad-association module 136 has associated advertisement 404(2) with ad-insertion point 502. As previously illustrated, advertisement 404(2) was determined to be the second-most globally relevant advertisement as well as the second most relevant advertisement for ad-insertion point 502. Next, module 136 has associated advertisement 404(1) with ad-insertion point 504. Also as illustrated, advertisement 404(1) was determined to be both the most globally relevant advertisement as well as the most locally relevant advertisement, relative to ad-insertion point 504. Finally, FIG. 6 illustrates that both advertisement 404(4) and advertisement 404(2) have been associated with ad-insertion point 506.

With these advertisement associations in mind, imagine now that user 106 receives (e.g., downloads, streams, etc.) video file 406 at computing device 108 and consumes the video file with media player 114. At a time corresponding to ad-insertion point 502, the player would play and the user would view advertisement 404(2). If the advertisement is embedded within the file, then the video will resume at the end of the advertisement. If the advertisement overlays or is played adjacent the video, however, then the video would continue playing during the advertisement. At a time corresponding to ad-insertion point 504, meanwhile, the user will view advertisement 404(1). Finally, at a time corresponding to ad-insertion point 506, the user will view both advertisement 404(4) and advertisement 404(2), either serially, concurrently, or in an overlapping fashion.

As described above, multi-modal relevancy matching techniques enable ad-association server 120 to effectively choose advertisements to associate that are both relevant to a media file as a whole, as well as relevant to a particular ad-insertion point of the file. The use of both textual and non-textual information also better enables server 120 to determine the relevancy of an advertisement. In addition, by relying on both textual and non-textual information, server 120 is able to match advertisements with insertion points in a manner that will be less aurally and visually disrupting to the consuming user. When advertisements are associated with relevant points of a media file in a smoother fashion, the effectiveness of the advertisements should increase, as should the user's enjoyment.

Operation

FIGS. 7-9 depict flow diagrams of illustrative processes 700, 800, and 900 for implementing relevancy matching between entities, such as advertisements, and insertion points in a media file. Each of these processes is illustrated as a collection of blocks in a logical flow graph, which represent a sequence of operations that can be implemented in hardware, software, or a combination thereof. In the context of software, the blocks represent computer-executable instructions that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described blocks can be combined in any order and/or in parallel to implement the process.

FIG. 7 illustrates process 700, which includes operation 702. Operation 702 represents calculating a global relevancy based on textual and/or non-textual information. Next, operation 704 represents determining an ad-insertion point in a media file. Operation 706, meanwhile, calculates a local relevancy based on the textual and/or non-textual information. Finally, operation 708 represents associating an advertisement with the ad-insertion point based, at least in part, on the calculated global and local relevancies.

Additionally, note that operation 708 may include a series of sub-operations 708(1) and 708(2). Sub-operation 708(1) calculates an overall relevancy score, while sub-operation 708(2) associates an advertisement having a highest overall relevancy score with the ad-insertion point.

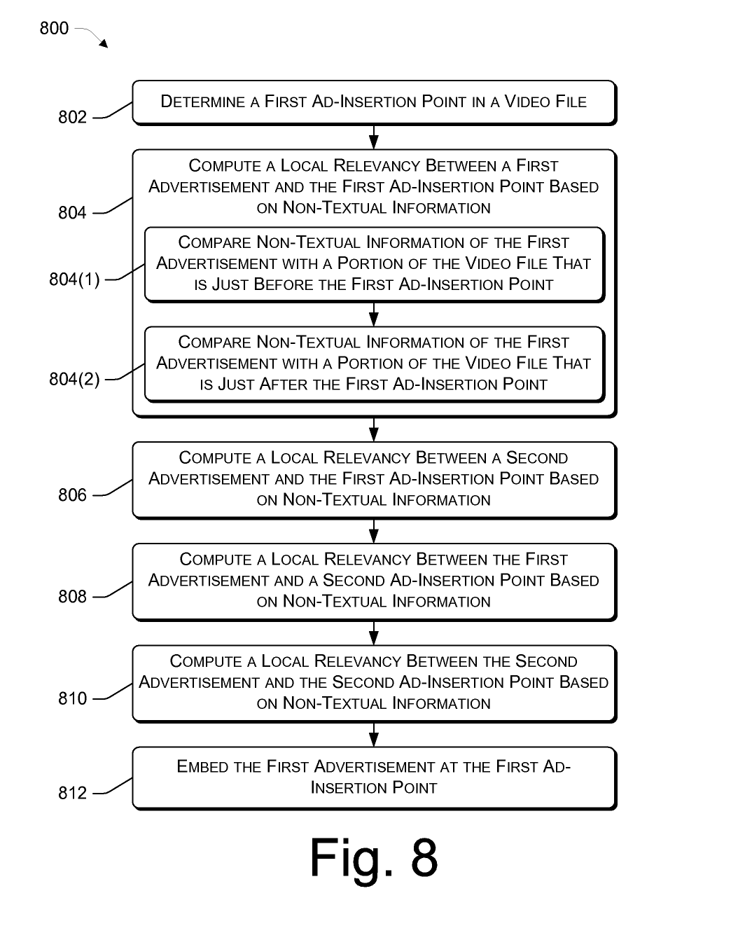

FIG. 8, meanwhile, illustrates process 800. Process 800 includes operation 802, which represents determining a first ad-insertion point in a video file. Next, operation 804 computes a local relevancy between a first advertisement and the first ad-insertion point based on non-textual information. Operation 804 may include a series of sub-operations, including sub-operation 804(1), which compares non-textual information of the first advertisement with a portion of the video file that is just before the first ad-insertion point. Sub-operation 804(2) then compares non-textual information of the first advertisement with a portion of the video file that is just after the first ad-insertion point.

Next, operation 806 computes a local relevancy between a second advertisement and the first ad-insertion point based on non-textual information. Operation 808 then computes a local relevancy between the first advertisement and a second ad-insertion point, while operation 810 computes a local relevancy between the second advertisement and the second ad-insertion point. Finally, operation 812 embeds the first advertisement at the first ad-insertion point.

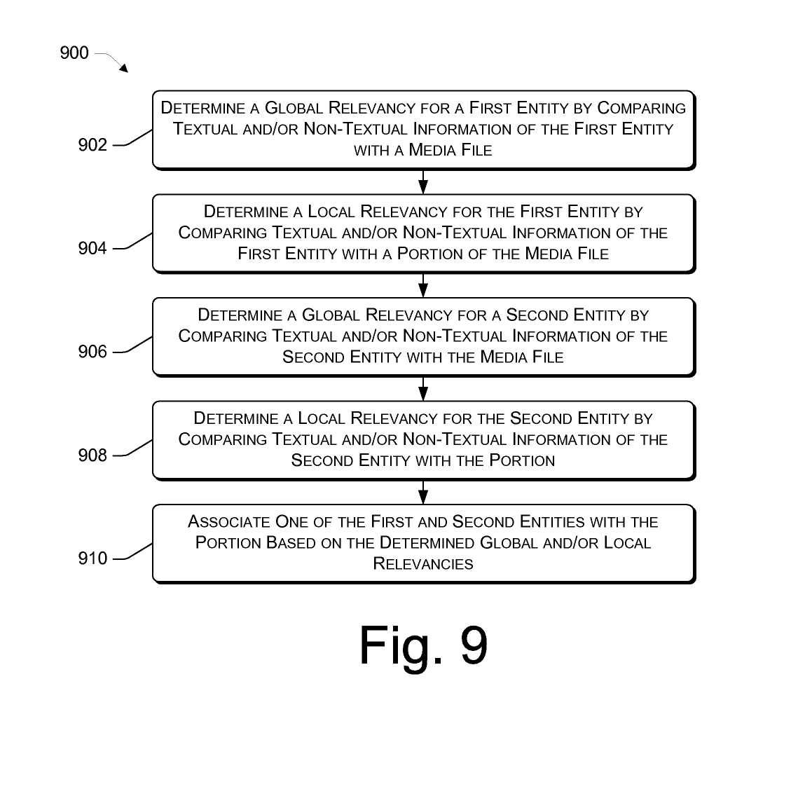

FIG. 9 illustrates process 900, which includes, at operation 902, determining a global relevancy for a first entity by comparing textual and/or non-textual information of the first entity with a media file. Operation 904 then represents determining a local relevancy for the first entity by comparing textual and/or non-textual information of the first entity with a portion of the media file. Operation 906, meanwhile, determines a global relevancy for a second entity by comparing textual and/or non-textual information of the second entity with the media file. Operation 908 then determines a local relevancy for the second entity by comparing textual and/or non-textual information of the second entity with the portion of the media file. Finally, operation 910 associates one of the first and second entities with the portion based on the determined global and/or local relevancies.

### CONCLUSION

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A method comprising:
calculating a global relevancy between each of multiple advertisements and a media file;
determining an ad-insertion point in the media file, the ad-insertion point representing a position of the media file to be associated with one of the multiple advertisements;
calculating a local relevancy between each of the multiple advertisements and the ad-insertion point in the media file; and
associating one of the multiple advertisements with the ad-insertion point based, at least in part, on the determined global and local relevancies of the multiple advertisements.

2. A method as recited in claim 1, wherein the calculating of the global relevancy between each of multiple advertisements and the media file comprises comparing textual information associated with each of the multiple advertisements with textual information associated with the media file.

3. A method as recited in claim 1, wherein the calculating of the global relevancy between each of multiple advertisements and the media file comprises comparing non-textual information associated with each of the multiple advertisements with non-textual information associated with the media file.

4. A method as recited in claim 1, wherein the calculating of the local relevancy between each of the multiple advertisements and the ad-insertion point comprises comparing textual information associated with each of the multiple advertisements with textual information associated with the ad-insertion point.

5. A method as recited in claim 1, wherein the calculating of the local relevancy between each of the multiple advertisements and the ad-insertion point comprises comparing non-textual information associated with each of the multiple advertisements with non-textual information associated with the ad-insertion point.

6. A method as recited in claim 1, wherein the calculating of the local relevancy between each of the multiple advertisements and the ad-insertion point comprises comparing aural-relevance information of each of the multiple advertisements with aural-relevance information of a portion of the media file that borders or surrounds the ad-insertion point.

7. A method as recited in claim 1, wherein the calculating of the local relevancy between each of the multiple advertisements and the ad-insertion point comprises comparing visual-relevance information of each of the multiple advertisements with visual-relevance information of a portion of the media file that borders or surrounds the ad-insertion point.

8. A method as recited in claim 1, wherein the associating of the advertisement with the ad-insertion point comprises:
calculating, for each of the multiple advertisements, an overall relevancy score based on each respective calculated global and local relevancy; and
associating an advertisement having a highest overall relevancy score with the ad-insertion point.

9. A method as recited in claim 1, further comprising comparing: (1) a profile or past behavior of a particular user with (2) textual information of each of the multiple advertisements, and wherein the associating of the advertisement with the ad-insertion point is also based, at least in part, on the comparison of the profile or the past behavior with the textual information.

10. A method as recited in claim 1, further comprising comparing: (1) user-inputted or advertiser-inputted information with (2) textual information of each of the multiple advertisements, and wherein the associating of the advertisement with the ad-insertion point is also based, at least in part, on the comparison of the inputted information with the textual information.

11. One or more computer-readable media storing computer-executable instructions that, when executed on one or more processors, performs acts comprising:
determining, in a video file, an ad-insertion point that represents a position of the video file to be associated with an advertisement; and
computing a local relevancy between a particular advertisement and the ad-insertion point based, at least in part, on non-textual information.

12. One or more computer-readable media as recited in claim 11, wherein the non-textual information comprises one or more of: a frequency of beats of the particular advertisement and a portion of the video file, dominant colors of the particular advertisement and a portion of the video file, camera or object motions of the particular advertisement and a portion of the video file, texture of the particular advertisement and a portion of the video file, or detected concepts of the particular advertisement and a portion of the video file.

13. One or more computer-readable media as recited in claim 11, further storing computer-executable instructions that, when executed on the one or more processors, perform an act comprising embedding the particular advertisement within the video file at the ad-insertion point such that when a user plays the video file the user views the particular advertisement at the ad-insertion point.

14. One or more computer-readable media as recited in claim 11, wherein the ad-insertion point is a first ad-insertion point and the particular advertisement is a first advertisement, and further storing computer-executable instructions that, when executed on the one or more processors, perform acts comprising:
computing a local relevancy between a second advertisement and the first ad-insertion point based, at least in part, on non-textual information;
computing a local relevancy between the particular advertisement and a second ad-insertion point based, at least in part, on non-textual information; and
computing a local relevancy between the second advertisement and the second ad-insertion point based, at least in part, on non-textual information.

15. One or more computer-readable media as recited in claim 11, wherein the computing of the local relevancy between the particular advertisement and the ad-insertion point comprises comparing non-textual information of the particular advertisement with: (1) non-textual information of a portion of the video file that is before the ad-insertion point, and (2) non-textual information of a portion of the video file that is after the ad-insertion point.

16. A method comprising:
determining a local relevancy for a first entity by comparing non-textual information of the first entity with non-textual information of a portion of a media file;
determining a local relevancy for a second entity by comparing non-textual information of the second entity with non-textual information of the portion of the media file; and
associating one of the first entity and the second entity with the portion of the media file based, at least in part, on the determined local relevancies of the first and second entities.

17. A method as recited in claim 16, wherein the portion of the media file comprises less than all of the media file.

18. A method as recited in claim 16, wherein the first and second entities each comprise a video advertisement and the media file comprises a video file.

19. A method as recited in claim 16, wherein the local relevancies of the first and second entities are further determined, at least in part, by comparing textual information of the entities with textual information of the portion of the media file.

20. A method as recited in claim 16, further comprising:
determining a global relevancy for the first entity by comparing non-textual or textual information of the first entity with non-textual or textual information of the media file;
determining a global relevancy for the second entity by comparing non-textual or textual information of the second entity with the non-textual or the textual information of the media file; and
wherein the associating of the first or second entity with the portion of the media file is further based, at least in part, on the determined global relevancies of the first and second entities.
